(19) United States
(12) Patent Application Publication
(10) Pub. No.: US 2003/0110011 A1
(43) Pub. Date: Jun. 12, 2003

(54) Software unlawful use prevention apparatus

(76) Inventor: Satoshi Kyotoku, Tochigi (JP)

Correspondence Address: ROBIN BLECKER & DALEY, 2ND FLOOR, 330 MADISON AVENUE, NEW YORK, NY, 10017, US

(21) Appl. No.: 09/819,209

(22) Filed: Mar. 28, 2001

(30) Foreign Application Priority Data
Mar. 31, 2000 (JP) 096472 / 2000
Apr. 25, 2000 (JP) 124827 / 2000

(51) Int. Cl. G06F 11/30; G06F 15/00; G21C 17/00

(52) U.S. Cl. 702/186

(57) ABSTRACT

According to the present invention, an apparatus that executes a program employs a GPS signal received by a GPS receiver to examine the location whereat a program is installed and the permitted usage time limit for the program. When the location is outside an allowed usage range, or when the permitted usage time limit has expired, the apparatus terminates the program. Further, an apparatus that permits or inhibits remote accesses examines GPS data received by an apparatus performing a remote access, or information recorded on an optical part of that apparatus, and halts the remote access from a location other than a predetermined location.

### BACKGROUND OF THE INVENTION

1. Field of the Invention

The present invention relates to an apparatus for preventing the unlawful use of software.

2. Related Background Art

Recently, flash memory has come to be employed not only for common personal computers, but also for device control programs for apparatuses used for specific operations, such as semiconductor manufacturing apparatuses, or mobile terminals, so that all or part of the available computer functions can be provided merely by updating the software.

Thus, generally, to install and apply a new function, a user must merely procure applicable software; the need to purchase additional hardware is obviated.

However, a problem has arisen concerning illegal software use: an unscrupulous user may purchase a single software package for a new function, and may then unlawfully copy the software and use the copies for installations on twenty units or so.

This is an extremely harmful act, for since an immense amount of money may be expended to develop software applications for which only limited distribution is possible, for example, a software application that is employed for semiconductor aligners used in the manufacture of semiconductors, unit prices must be established that frequently exceed several tens of millions of yen.

Thus, if such an expensive software program is illegally copied and employed, it will be impossible for the developer to recoup the expenses associated with its development, and it is therefore imperative that radical countermeasures be provided that can prevent such unlawful activities.

Conventionally, as countermeasures for preventing the production of illegal copies, special noise, for example, may be recorded on a software supply medium to prevent its use as a master medium for copying, or a part supplied with a serial number identifier (a serial ID) may be attached to hardware, the hardware main body that operates the software can be specified by identifying the hardware. Further, a hardware key may be attached to an external device interface, such as the printer port of the main body of hardware, to inhibit the operation of the software if communication with the hardware is not established.

However, in actuality, a copy prevention countermeasure (a protection method) can easily be circumvented by an engineer working in a semiconductor manufacturing facility.

Further, because software is often expensive, before purchasing an application a user may desire to employ the application for a specific evaluation period, and may request that an evaluation version of the software be provided.

As a countermeasure employed is such a case, a software supplier may include in the binary code for the evaluation version a set of instructions that inhibits the use of the software after a hardware timed, specific evaluation period has elapsed.

However, many cases have surfaced wherein the timings for apparatuses have been intentionally turned back, so that evaluation versions can be continuously, and illegally used.

Recently, as the development of network techniques has continued, it has become possible not only to use common personal computers to remotely access apparatuses on public networks, but also to easily employ for this purpose apparatuses that perform specific operations (semiconductor manufacturing apparatuses) and mobile terminals.

According to the remote access techniques, a variety of applications can be employed. For example, via a communication line, the latest software can be downloaded for immediate use, or a 24 hour maintenance operation can be provided for the timely evaluation of equipment failures, or the correction of operating malfunctions or the adjustment of apparatus parameters, without maintenance personnel having to visit equipment installation sites.

However, as the network society has developed and spread, many cases continue to be reported wherein unscrupulous third parties have broken into computer networks by stealing passwords or hacking, and have caused serious damage, such as the alteration or the erasure of data, the accessing of confidential data, or the leakage of customer data.

In response, a variety of methods have been proposed to prevent the unlawful access and damage of networks.

Of these, there is a call back method, according to which a remote access destination places a call back to a telephone number for which access is approved; an approved telephone number method, according to which a search is made of a sender number notification list, which includes approved access telephone numbers, and a connection is refused if a telephone number is not found in the approved telephone number list; or a one-time password method, according to which a remote accessing client and a server employ a one-time password generator (a system for generating a password at the time of an access) to approve an access in accordance with a counter synchronization method or in accordance with a challenge/response method that conforms to ANSI standards.

However, network cracking/hacking software that is now being distributed via the Internet has gradually been strengthened by crackers/hackers who possess a high level of technical competence, until presently, intrusions are being reported at systems that it was presumed were secure

### SUMMARY OF THE INVENTION

To resolve the above problems, it is one objective of the present invention to uncover and prevent the unlawful use of software, such as illegal copying.

It is another objective of the present invention to prevent the use of software at a location other than a predetermined location.

It is an additional objective of the present invention to precisely prevent the unlawful use of software by employing a GPS.

It is a further objective of the present invention to precisely prevent illegal accesses.

It is a still further objective of the present invention to prevent remote accesses that originate at locations other than a predetermined location.

### BRIEF DESCRIPTION OF THE DRAWINGS

FIG. 1 is a diagram showing a first hardware configuration for a semiconductor aligner;

FIG. 2 is a flowchart showing the processing for a first embodiment;

FIG. 3 is a flowchart showing the processing for a second embodiment;

FIG. 4 is a diagram showing a second hardware configuration for a semiconductor aligner;

FIG. 5 is a diagram showing a hardware configuration for a server;

FIG. 6 is a flowchart showing the processing performed for a third embodiment;

FIG. 7 is a flowchart showing the processing performed for a fourth embodiment;

FIG. 8 is a specific diagram showing a semiconductor aligner;

FIG. 9 is a flowchart showing the processing performed for a fifth embodiment; and

FIG. 10 is a flowchart showing the processing performed for a sixth embodiment.

### DETAILED DESCRIPTION OF THE PREFERRED EMBODIMENTS

The preferred embodiments of the invention will now be described while referring to the accompanying drawings.

In the following embodiments, an explanation will now be given for a system wherein software for a semiconductor aligner, such as a stepper (an optical reduction projection aligner), is protected from unlawful usage, such as illegal copying.

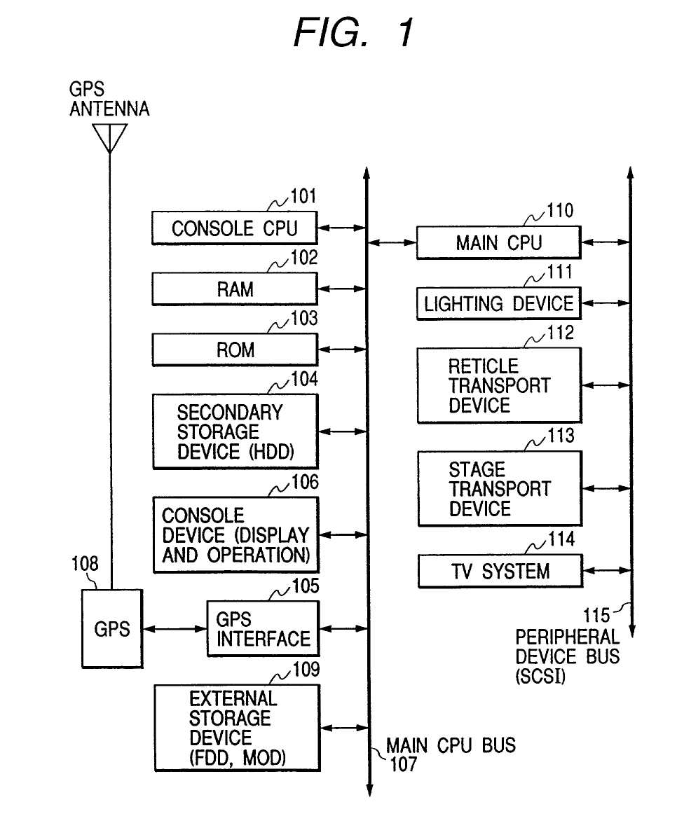

The hardware configuration of a semiconductor aligner is shown in FIG. 1.

A console CPU 101 controls the operation of the semiconductor aligner by using the console display and a console command entry. A RAM 102 is used by the CPU 101 to store an execution program and data, and a ROM 103 is used to store a program.

A secondary storage device 104 is used to store data and programs, and in this embodiment, expensive software to be protected from unlawful use is stored in the secondary storage device 104. A general software program constructs a file system, for the management of files, in the secondary storage device 104, and a magnetic disk drive, such as a hard disk, can be employed for the secondary storage device 104. However, depending on the apparatus configuration, the characteristics and the operation of the exposure process, software rewritable parts, such as a flash memory, an NV-RAM (nonvolatile memory) and an EEPROM, may be employed.

A GPS (Global Positioning System) interface 105 communicates with a GPS receiver 108, which will be described later. Generally, a serial communication interface, such as an RS232C, is employed as the GPS interface 105, and depending on the amount of data involved in GPS communication, a parallel interface or an SCSI interface may be employed. Further, generally, a non-procedural asynchronization method is employed as a communication protocol for the communication interface 105 and the GPS receiver 108. However, a synchronization method and binary procedures may also be employed.

With a console device 106, an operator can issue an instruction to the console CPU 101. Generally,a CRT, a liquid crystal display device, an EL panel or a plasma display can be employed as the display panel for the console device 106. A keyboard for entering a command is frequently employed as the input unit for the console device 106; however, a pen input device (a tablet), using an electronic pen, or a touch panel may be employed as the input unit.

The GPS receiver 108 decodes a digital signal in a GPS wave from a satellite that is received at a GPS antenna, and obtains information (positional information) for the latitude and the longitude whereat the semiconductor aligner is located. When the semiconductor aligner is located in an area, such as a clean room, into which an electronic wave can not be projected, a GPS antenna is constructed by extending an electric line to the outside where it can receive an electronic wave.

An FDD (Floppy Disk Drive) or an MOD (magneto-optical disk drive) can be employed as an external storage device 109.

In this configuration, an expensive software program, which is to be protected, is stored on a storage medium, such as an FD or an MO, and is read and supplied by the external storage device 109.

When an expensive software program, the unlawful use of which is to be prevented, can be installed via a network, the external storage device 109 is not required. But when the network installation is employed, a LAN interface must be independently connected to a main CPU bus 107. However, in this embodiment, since the basic operation is the same, a detailed explanation will not be given for a system that uses a network installation.

A main CPU 110 provides overall control for the various controllers that constitute the semiconductor aligner. The main CPU 110 and the console CPU 101 are operated as the semiconductor aligner by connecting them to the main CPU bus 107.

A lighting device 111 controls a light source for exposing a semiconductor manufacturing wafer, and a reticle transport device 112 controls the insertion and removal of a reticle (a photomask), on which a pattern is drawn, that is used for the exposure and the development of the pattern on the semiconductor manufacturing wafer. A stage transport device 113 drives an XY stage, on which the semiconductor manufacturing wafer is mounted, to expose the wafer using a step-and-repeat method, while the semiconductor manufacturing wafer is accurately positioned by an alignment TV system 114. The devices 111 to 114 are controlled by the main CPU 110 via a peripheral device bus 115. Although in this embodiment an SCSI bus is used for the peripheral device bus 115, it should be noted that any standard general-purpose bus may be so employed.

As was previously described, since the software program, the unlawful use of which is to be prevented, is stored on a supply medium (a floppy disk or a magneto-optical disk), the supply medium is mounted in the external storage device 109 and the program is read therefrom and supplied as necessary.

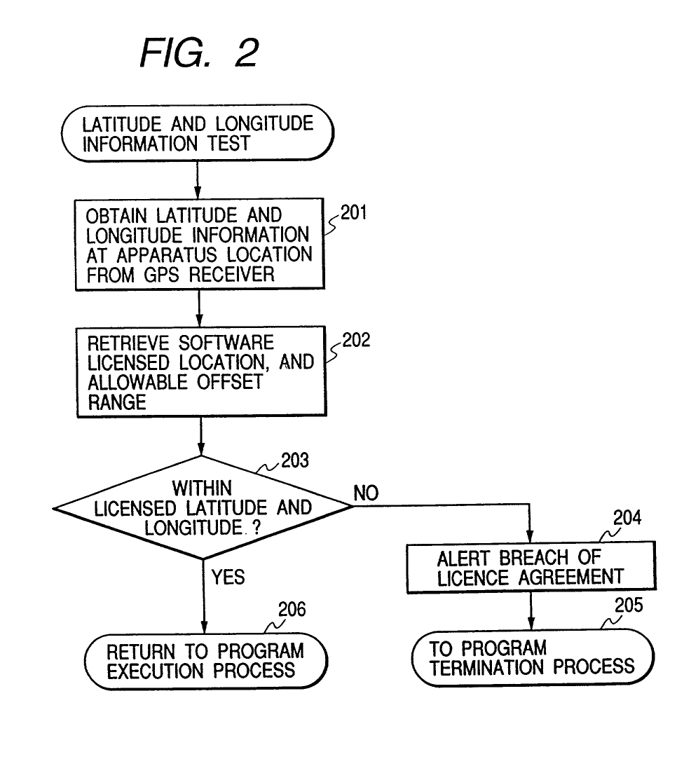

The processing for the latitude and longitude information test will now be described while referring to the flowchart in FIG. 2. The flowchart in FIG. 2 shows a part of the program for the CPU 101 or 110 that constitutes a computer.

During the generation of a compile link before the software program, which is to be protected, is stored on the above supply medium, latitude and longitude information (information concerning the latitude and longitude of the location whereat the semiconductor aligner on which the software will be mounted is installed) is entered by a software manager, and along with information for a permissible latitude and longitude offset range (a permissible travel distance range) and the program routine in the flowchart in FIG. 2, is embedded in several to several hundreds of places in the binary code of the software program.

A program according to which the main CPU 110 controls the devices 111 to 114 during the semiconductor manufacturing process is included in the software program, which is to be protected, as well as a program for the console CPU 101.

The binary code for this software program is stored in the secondary storage device 104. And when the main CPU 110, or the console CPU 101, executes the software program, the binary code is read from the secondary storage device 104 to the RAM 102.

The reading of the software program, which is to be protected, using the external storage device 105, and the storage of the software program in the secondary storage device 109 are performed by the CPU 101, based on the program stored in the ROM 103.

An explanation will now be given for the processing for a second embodiment, for examining the installation of the semiconductor aligner, that is performed by the main CPU 110 or the CPU 101 by reading the software program code stored in the RAM 102. The program routine in FIG. 2 is also embedded in the semiconductor manufacturing program the main CPU 110 uses to control the devices 111 to 114, and is read and executed during the execution of the semiconductor manufacturing program. In addition, the program routine in FIG. 2 is also embedded in the middle of the program that is executed by the console CPU 101.

First, at step 201, latitude and longitude information indicating the location whereat the semiconductor aligner is installed is obtained from the GPS receiver 108.

At step 202, latitude and longitude information that is embedded in the program code of the software and that indicates the location of the semiconductor aligner, and the allowable latitude and longitude offset range (an allowable travel distance range) are retrieved. Various latitude and longitude offset ranges can be set as user information, and up to a 10 km square range can be set, consonant with the size of a factory.

Then, at step 203, the latitude and longitude information obtained from the GPS receiver 108 at step 201 is compared with the latitude and longitude information read from the software program code at step 202. When the location designated by the latitude and longitude information does not fall outside the offset range limits, execution of the semiconductor manufacturing program is continued (step 206).

But when the location designated by the latitude and longitude information falls outside the offset range, a warning message that a license agreement may have been breached is displayed by the console device 106 (step 204). The user is then requested to confirm the message, and the execution of the program is halted (step 205). That is, when a program has been illegally copied, it is highly probable that the latitude and longitude information embedded in the program will differ from the latitude and longitude information obtained from the GPS receiver 108, and when this occurs during the execution of a program, it is assumed that the program being executed is an illegal copy.

Through the above operation, it can be detected that software has been illegally copied, and is being used at a location other than the location at which the licensed apparatus is installed. In this case, since the execution of the program is halted, further illegal usage can be prevented. In this embodiment, based on the program routine in FIG. 2, the console CPU 101 of the semiconductor aligner functions as the software manager for the invention.

As was explained while referring to FIG. 2, the software was managed by using the latitude and longitude information for the semiconductor aligner obtained from the GPS receiver 108. An explanation will now be given for a second embodiment wherein time information is obtained from the GPS receiver 108 and this time information is used to manage the software. The hardware configuration of the semiconductor aligner is the same as that shown in FIG. 1.

While a software program for which a limited usage time is established is stored on a supply medium (a floppy disk or a magneto-optical disk), the supply medium is mounted on the external storage device 109 and the software program is read from it.

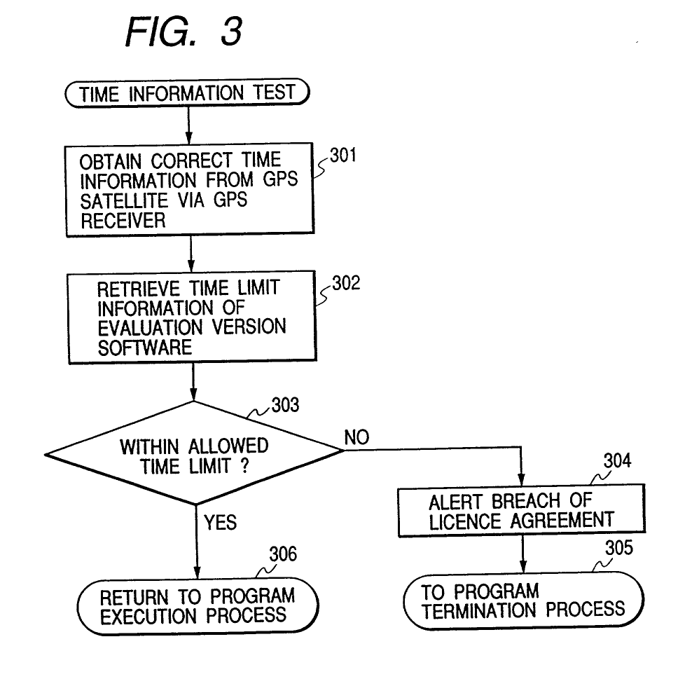

The processing for the time information test according to the second embodiment will now be described while referring to the flowchart in FIG. 3. The flowchart in FIG. 3 represents a part of the program for the CPU 101 or 110 that constitutes a computer.

During the generation of a compile link before a software program for which a limited usage time has been established is stored on the above supply medium, time limit information for the permitted usage time established for the evaluation of the software, and the program routine in the flowchart in FIG. 3 are embedded in several to several hundreds of places in the binary code of the software program.

A program according to which the main CPU 110 controls the devices 111 to 114 during the semiconductor manufacturing process is also included in the software program for which the limited usage time has been established, as is the program for the console CPU 101.

The binary code for this software program is stored in the secondary storage device 104, and when the main CPU 110 or the console CPU 101 executes the software program, the binary code is read from the secondary storage device 104 to the RAM 102.

The reading of the software program, for which the limited usage time is established, from the external storage device 105, and the storage of the software program in the secondary storage device 109 are performed by the CPU 101 based on the program stored in the ROM 103.

An explanation will now be given for the processing performed to examine the permitted usage time limit established for the evaluation software version, which the main CPU 110 executes by reading the software program code from the RAM 102. The program routine in FIG. 3 is also embedded in the middle of the semiconductor manufacturing program the main CPU 110 uses to control the devices 111 to 114, and is also retrieved and executed by the main CPU.

First, at step 301, the current time information is obtained from the GPS receiver 108.

At step 303, the time information obtained from the GPS receiver 108 at step 301 is compared with permitted usage time limit information retrieved from the software program code at step 302. When the time obtained from the GPS receiver 108 is within the permitted usage time limit established for the program, execution of the semiconductor manufacturing program is continued (step 306).

However, when the permitted usage time has expired, a warning message of that effect is displayed (step 304). The user is then requested to confirm the message, and the execution of the program is halted (step 305).

Through the above processing, since the correct time information can be obtained from the GPS receiver, it is possible to detect that a user, to permit the continuous, illegal use of evaluation version software, has intentionally changed the time setting for the clock in an apparatus, and further use of the software can be prevented.

Further, this configuration can be employed when data from a GPS receiver 108 is transmitted via a communication network, such as a LAN, without the interface for the GPS receiver 108 being embedded in the apparatus in FIG. 1. This configuration can also be effectively used when a semiconductor aligner is installed in a clean room, and it is difficult for an antenna to be extended from a GPS receiver 108 embedded in the apparatus to a location that the GPS broadcast wave can reach.

In order to prevent the alteration of the contents of a network packet transmitted by the GPS receiver 108, or illegal copying effected by the decoding of data, it is preferable that an interface that can not be separated from the GPS receiver 108 be provided inside an apparatus.

In the above embodiments, as explained while referring to FIGS. 1 to 3, if data received from the GPS receiver 108 is altered by specific means and the system no longer provides adequate protection, a license manager may transmit to a user a notification to that effect.

Specifically, data received from the GPS receiver 108 is continuously transmitted to a license manager via a communication network, such as the Internet. This data is compared with data obtained by a GPS receiver at the license manager site to determine whether the data received by the GPS receiver 108 has been altered at the site whereat the licensed program is being used.

In this example, an interface for connecting to a communication network, such as the Internet, is required to be mounted inside the semiconductor manufacturing apparatus in FIG. 1. This interface can be connected to the main CPU bus 107.

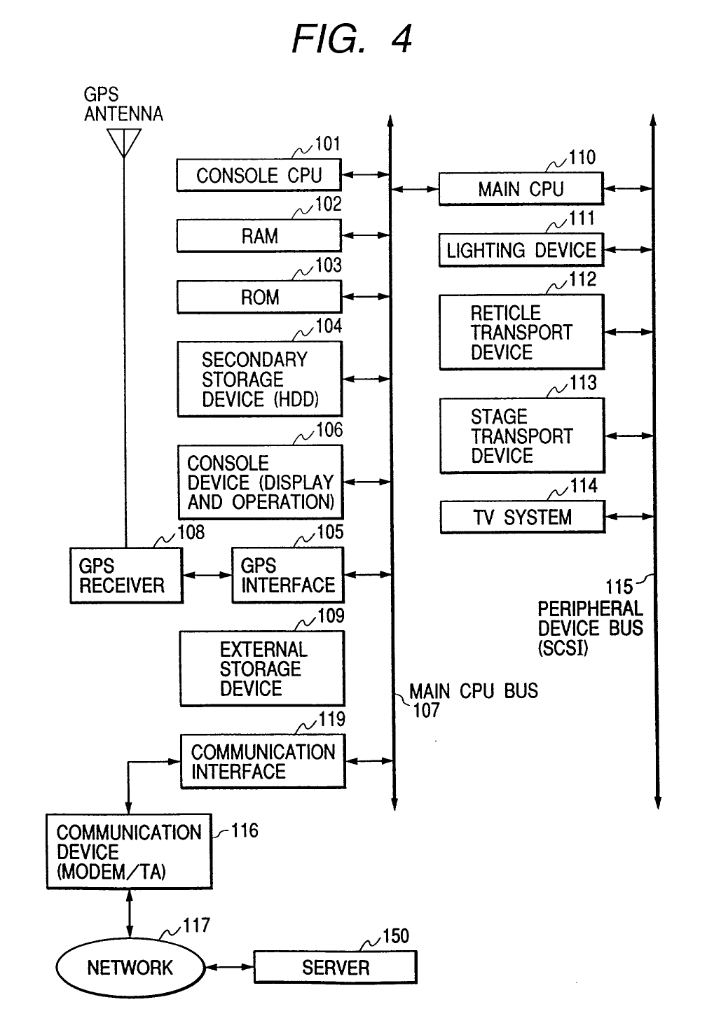

FIG. 4 is a diagram showing the configuration of a semiconductor manufacturing apparatus equipped with a communication device 116 for connecting a communication network 117 and a communication interface 119. The remainder of the configuration is the same as that shown in FIG. 1. In FIG. 4, the communication network 117 is the Internet, and a server 150 is a license manager.

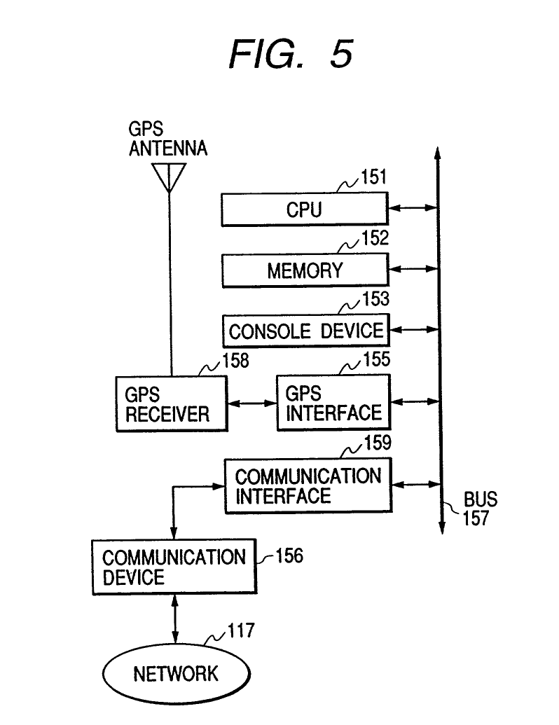

FIG. 5 is a diagram showing the arrangement of the server 150. The server 150 comprises: a CPU 151, a memory 152, a console device 156, a GPS interface 155, a GPS receiver 158, a communication interface 159, and a communication device 156. The GPS interface 155, the GPS receiver 158, the communication interface 159 and the communication device 156 have the same arrangements as the GPS interface 105, the GPS receiver 108, the communication interface 119 and the communication device 116 in FIG. 4. In addition to the arrangement shown in FIG. 5, the server 150 has a circuit that functions as a server.

The communication device 116 is a modem when the communication network 117 is an analog public network, or a digital communication terminal adaptor (TA) when the communication network 117 is a digital public network, such as is represented by an ISDN connection, or when the communication network 117 is a private digital network. Or, the communication device 116 is a digital communication card for a PHS (Personal Handy phone System) or a portable telephone when the communication network 117 is a digital communication network for a PHS or a portable telephone. The communication network 117 also includes the Internet.

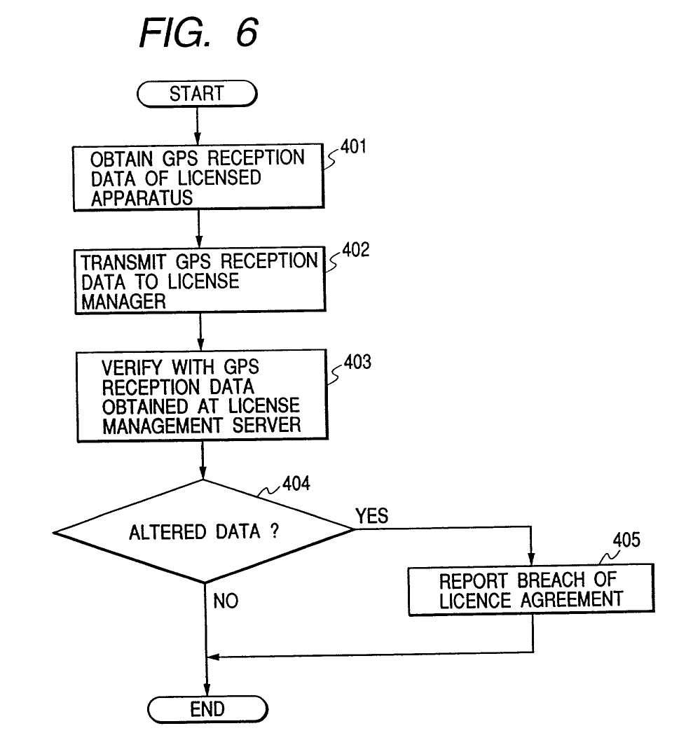

The processing for a fourth embodiment, determining whether the protection capability has been damaged, will now be described while referring to the flowchart in FIG. 6. In this embodiment, the console CPU 101 (or the main CPU 110) performs steps 401 and 402 in FIG. 6, and the CPU 151 performs steps 403, 404 and 405. The program routines at steps 401 and 402 in FIG. 6 are performed when the console CPU 101 (or the main CPU 110) repetitively reads and executes the program routine in FIG. 5. Steps 403 to 405 show one part of the program executed by the CPU 151 that constitutes a computer. This program is stored in the memory 152 so that the CPU 151 can read it.

At the semiconductor aligner, at step 401 a signal obtained by the GPS receiver 108 is decoded and the GPS reception data are obtained. Then, at step 402 the GPS reception data is transmitted by the communication device 116, via the communication network 117, to the server 150, which is the license manager.

In the server 150, the license manager, at step 403 the CPU 151 receives the GPS reception data from the destination whereat the licensed software is being used (the semiconductor manufacturing apparatus in FIG. 5) through the communication device 156, and compares the GPS reception data with the GPS reception data that is obtained by the license manager GPS receiver 158. At step 404, the difference between the data is employed to determine whether the GPS reception data received from the destination whereat the license software is being used (the semiconductor manufacturing apparatus) was actually obtained by decoding a signal that was received from a GPS satellite.

When the GPS reception data transmitted by the semiconductor manufacturing apparatus differ from the GPS data received at the server 150, it is ascertained that the GPS reception data provided by the semiconductor manufacturing apparatus are actually not the GPS reception data, but are instead, illegally prepared data.

When the result obtained at step 404 indicates that the data differ considerably, it is assumed that some alteration of the data was performed, and program control is shifted to step 405. At step 405, a message that the license agreement may have been breached is displayed by the console device 156 for the license manager. Therefore, evidence that the protection capability has been damaged can be obtained and a warning can be issued to the user who is employing the licensed software, or the GPS reception data can be employed as material evidence.

While referring to FIG. 4, an explanation will now be given for a semiconductor aligner, such as a stepper (optical reduction projection aligner), that can provide a service, such as remote maintenance, by remotely accessing the server 150. This service includes the changing of various parameters for the semiconductor manufacturing process, and the changing of a control program for the semiconductor manufacturing process.

The communication interface 119 performs a remote access by communicating with the communication device 116, which is connected to the external communication network (public telephone network, etc.) 117. Generally, a serial communication interface, such as an RS232C, is employed as the communication interface 119; however, a parallel interface or a high-speed interface, such as a USB, may be employed.

The communication device 116 can access a remote apparatus (the server 150) using a communication network 117, such as a public network.

Generally, a point-to-point connection (a PPP connection), using TCP/IP, is employed as the communication protocol for a remote access using the communication interface 119 and the communication device 116. However, any protocol can be employed so long as the remote access can be implemented, and basic procedures used for communication between personal computers can be employed.

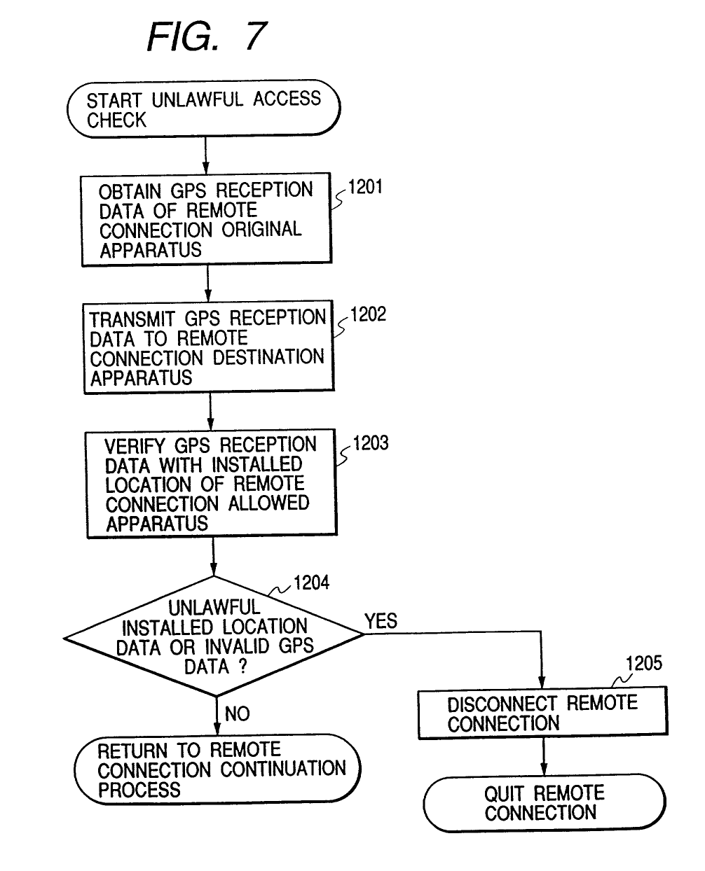

The processing for the prevention of unlawful access will now be described, in accordance with a fifth embodiment, while referring to the flowchart in FIG. 7. In FIG. 7, the console CPU 101 (or the main CPU 110) of the semiconductor manufacturing apparatus performs steps 1201 and 1202, and the CPU 151 of the server 150 performs steps 1203 to 1205. In this embodiment, the server 150 does not require the GPS receiver 158 and the GPS interface 155. The program shown at steps 1203 to 1205 is stored in the memory 152, so it can be retrieved by the CPU 152, which constitutes a computer.

Assume that the list of latitude and longitude information, for the location of a semiconductor aligner, and the information for the allowed latitude and longitude offset range (the travel distance range) have all been obtained in advance.

When a remote access is initiated between the semiconductor aligner and the server 150, the program routine in the flowchart in FIG. 7 is executed, and during the remote access is repeated many times, in accordance with a specific reference. In this embodiment, the semiconductor aligner transmits a remote access signal to the server 150.

The GPS receiver 108 embedded in the semiconductor aligner obtains the latitude and longitude information for the current location whereat the semiconductor aligner is installed (step 1201), and the GPS reception data (latitude and longitude information) is then transmitted to the server 150, which performs the remote access, via the communication interface 19 and the communication device 116 (step 1202).

In the server 150, the CPU 151 receives the GPS reception data from the semiconductor aligner via the communication device 156 and the communication interface 159. Then, the CPU 151 compares the latitude and longitude information, which is included in the GPS reception data for the location of the apparatus, with the latitude and longitude information that indicates the location of the user apparatus for which the remote access should be approved, and determines whether the difference falls within the allowed latitude and longitude offset range (step 1203). For this, the CPU 151 reads, from the memory 152, the latitude and longitude information for the location of the user apparatus and the allowed latitude and longitude offset range.

When, as a result of the determination, it is found that the latitude and longitude information that is included in the GPS information for the location of the apparatus has been shifted and define a location outside the offset range, it is ascertained that this data is unlawful location data or invalid GPS reception data that has been altered or forged (step 1204). Program control is then shifted to step 1205, and the communication device 156 is disconnected from the semiconductor aligner. The remote access is thereafter terminated.

Through the above processing, the location of a semiconductor aligner for which a remote access is permitted is stored in the memory 152, so that an illegal access can be prevented from a location other than the location of the semiconductor aligner for which a remote access is permitted.

Since remote accesses are frequently used for network connections, such as for remote maintenance performed between points, spread all around the world, whereat semiconductor aligners are located, the unlawful remote access prevention system of this embodiment is especially effective.

For actual operation, the method in this embodiment, the conventional method, such as a call back method or a method for transmitting an inquiry to the telephone number of an incoming call, or a one time password method may be employed.

In the above explanation given while referring to FIG. 7, an unlawful access was prevented by transmitting the latitude and longitude information for a semiconductor aligner obtained by the GPS receiver 108. An explanation will now be given for a fifth embodiment wherein an unlawful access is prevented by transmitting the unique apparatus ID that is written in the optical part or the optical medium of the semiconductor aligner.

The basic structure of the hardware system for the semiconductor aligner is the same as that explained in FIG. 4, except that the GPS receiver 108 and the GPS interface 105 are not required, and instead, ID reading means for reading an inherent apparatus ID is required.

Upon the receipt of an instruction from the main CPU 110, the semiconductor aligner activates the lighting device 111. A device, for example, the reticle transport device 112, reads the inherent apparatus ID written in the reticle, and transmits the ID data, via the peripheral device bus 115, to the main CPU 110. In this example, the ID reading means is provided for the reticle transport device 112.

The ID data is written in the RAM 102 by the main CPU 110, and in accordance with an instruction from the console CPU 101, the ID data is transmitted to the communication interface 109 and the communication device 116, and is then output via the communication network 117 to the server 150, which performs the remote access. The ID data may be, for example, ASCII text, but it is preferable that data be encrypted when it is written on the reticle and that the encrypted data be transmitted to the server 150 that performs the remote access, and that server 150 decrypt the encrypted data using a secret key that it manages.

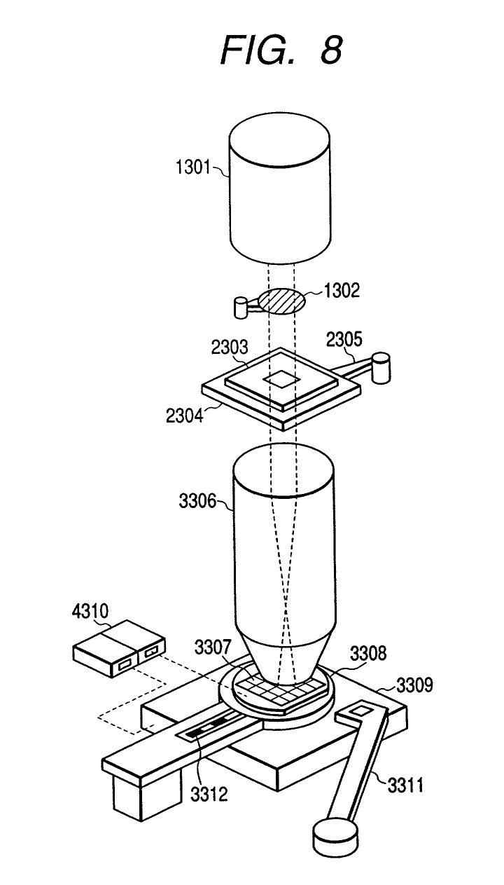

FIG. 8 is a specific diagram showing a semiconductor aligner. In FIG. 8, the semiconductor aligner comprises: a light source 1301, for the lighting device 111; a shutter 1302, for controlling the light exposure level; a reticle 2303, which serves as the original pattern for a circuit board; a reticle stage 2304, for supporting the reticle 2303; and a reticle hand 2305, for transporting the reticle 2303.

The semiconductor aligner further comprises: a projection lens 3306; a wafer 3307, which is a semiconductor substrate; a wafer Z state 3308, for supporting the wafer 3307 and for adjusting the focus relative to the light source 1301; an XY stage 3309, for moving the wafer Z stage 3308 in the XY direction; a laser interferometer 4310, for measuring the position of the XY state 3309; a wafer supply hand 3311, for supplying the wafer 3307 to the wafer Z stage 3308 for the exposure process; and a wafer collection hand 3312, for collecting the wafer 3307 from the wafer Z stage 3308 after the exposure process has been completed.

An optical apparatus, such as the semiconductor aligner shown in FIG. 8, includes special parts, such as the reticle 2303, the reticle stage 2304, the wafer Z stage 3308 and the XY stage 3309.

Minute pattern marks for micrometer units, such as a reticle set mark, a reticle reference mark, a stage reference mark, a TTL-AF reference mark and a wafer reference mark, which are used when positioning the reticle and the wafer, are written on the reticle 2303 and the stages 2304, 3308 and 3309. In order to read these patterns and marks, the semiconductor manufacturing apparatus is provided with various types of special optical scope that can read minute patterns.

In this embodiment, for the generation of an ID, the inherent apparatus ID is written as a minute pattern on a test reticle, a test wafer or a stage that probably is semi-permanently used, and is read by an optical scope.

A special optical device and an optical reader are required for the generation of the ID, and the ID can not be obtained if the reading means is not activated during a remote access. Thus, strong protection means can be provided relative to unlawful access due to the forging or the alteration of the ID or the bypassing of the ID reading means.

It is preferable that, through the character recognition provided for a digital image obtained by the optical scope, data, such as a character pattern, written on an optical part, such as a reticle, be regarded as character data.

For the character data, the serial number of the apparatus written using ASCII code may be used as the ID. However, it is more preferable that character data be obtained by encrypting the serial number using a secret key and that it be written on a special optical part, such as a reticle; that the encrypted ID be decrypted by using the secret key managed by the server 150 that performs the remote access; and that the decrypted ID be examined using the list, of the IDs for which remote access is permitted, that is stored in the memory 152.

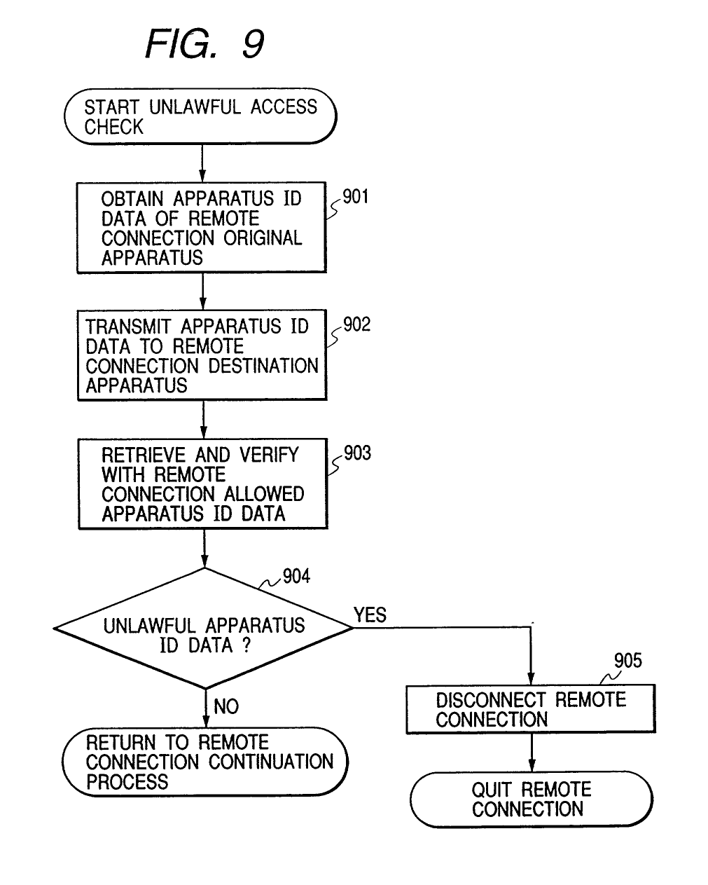

The unlawful access prevention processing will now be described while referring to the flowchart in FIG. 9. In FIG. 9, the CPU 151 performs steps 903 to 905. For this, in this embodiment, the server 150 does not need the GPS receiver 158 and the GPS interface 155. The program shown at steps 903 to 905 is stored in the memory 152, so that the CPU 151, which constitutes a computer, can read it.

Assume that the list of IDs for which remote access is permitted is stored in the memory 152 of the server 150 that remotely accesses the semiconductor aligner.

When a remote access between the semiconductor aligner and the server 150 is initiated, the program routine in the flowchart in FIG. 9 is initiated, and during the remote access is repeated many times in accordance with a predetermined reference. In this embodiment, the semiconductor manufacturing apparatus transmits a remote access signal to the server 150.

In the semiconductor aligner, the main CPU 110 employs the optical scope, which is provided for the reticle transport device 112, to obtain the apparatus ID that is written on a special optical part, such as a reticle, and writes the obtained ID in the RAM 102 (step 901). Then, the console CPU 101 reads the ID data from the RAM 102, and transmits it, via the communication interface 119 and the communication device 116, to the server 150, which performs the remote access (step 902).

In the server 150, the CPU 151 receives the ID data transmitted by the semiconductor aligner via the communication device 156 and the communication interface 159, and determines whether the ID is included on the list of IDs, for which remote access is permitted, that is stored in the memory 152 (step 903). When the ID is not included on the list, it is ascertained that the ID is illegal (step 904), program control is shifted to step 905, and the communication device 156 is disconnected from the semiconductor manufacturing apparatus. The remote accessing is thereafter terminated.

Since the server 150 can confirm the apparatus ID written to a special optical part, such as a reticle, the server 150 can immediately halt a remote access initiated by an unauthorized apparatus whose ID is not on the list of IDs, for which remote access is permitted, that is stored in the memory 152.

Through the above processing, a remote access can be prevented that is initiated by an unauthorized semiconductor aligner having an ID for which remote access is not permitted.

Means for using a special optical device, such as a scope, to read the ID on a special optical part is embedded in the remote access program, so that during a remote access, the reading process can be performed as needed in accordance with a specific reference.

That is, during the operation of the remote access program, the reading means is always active and reads the ID, so that it is very difficult for a remote access to be performed while avoiding the unlawful access prevention system of this embodiment.

Furthermore, as is described above, since the ID is encrypted by using the secret key managed by the server that performs the remote access, and the encrypted ID is written on a special optical part, such as a reticle, the encrypted ID can be transmitted in accordance with communication protocol, and the level of security can be improved.

Conventionally, the ID inherent to an apparatus and the secret key for the one-time password method are written and stored in a semiconductor storage device (memory). However, in this embodiment, the ID and the secret key are written on a part or a medium that has a special physical and optical characteristic, and are read optically. Thus, theoretically, even a hacker possessing a high level of technical competence will not be able to forge an ID, and an unlawful access can effectively be prevented.

An explanation will now be given for a sixth embodiment wherein an unlawful access is prevented by transmitting, to the server 150 that performs a remote access, the latitude and longitude information obtained by the GPS receiver 108, as explained in FIG. 7, and the apparatus ID written on the optical part or the medium of the semiconductor aligner, as explained in FIG. 9.

Further, in this embodiment, a multiple level unlawful access prevention system can be provided by writing, on the optical part or the medium of the semiconductor aligner, a composite ID that is a combination of the apparatus ID and the information for the location whereat the apparatus is installed. Thus, an unlawful access can be more effectively prevented, since the location information matches the GPS data obtained by the GPS receiver 108 when the semiconductor manufacturing apparatus is installed at the correct location.

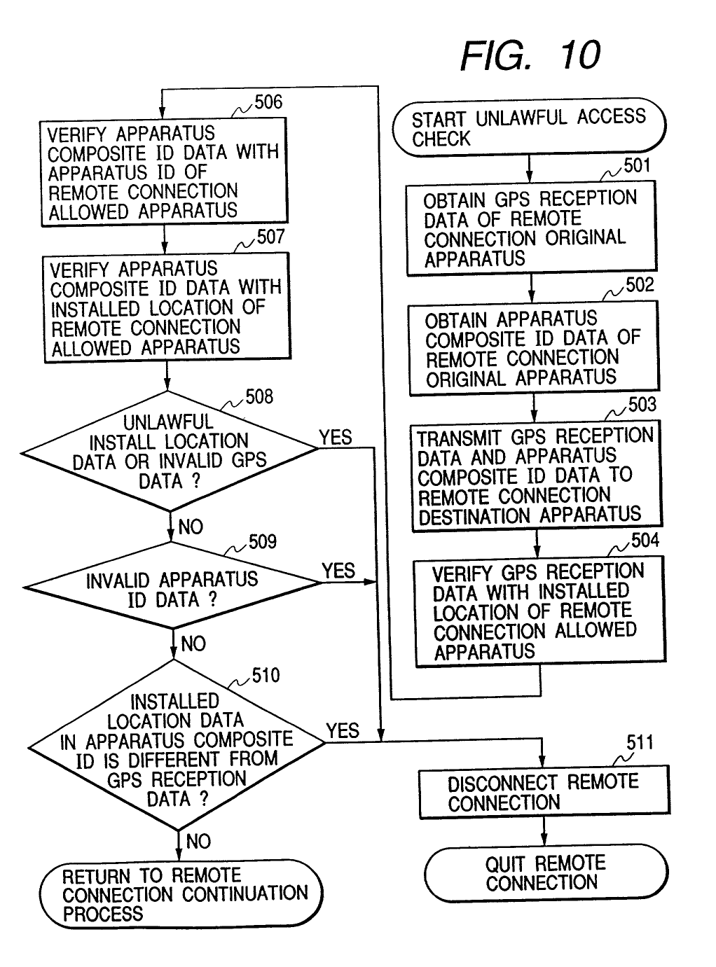

The unlawful access prevention processing for this embodiment will now be explained while referring to the flowchart in FIG. 10. In FIG. 10, the CPU 151 of the server 150 performs steps 504 to 511. In this embodiment, the server 150 does not need the GPS receiver 158 and the GPS interface 155.

When a remote access is initiated between the semiconductor aligner and the server 150, the execution of the program routine in the flowchart in FIG. 10 is begun, and during the remote access, is repeated as many times as necessary in accordance with a specific reference. In this embodiment, the semiconductor manufacturing apparatus transmits a remote access signal to the server 150.

In the semiconductor aligner, the console CPU 101 obtains, from the GPS receiver 108 embedded in the semiconductor aligner, the latitude and longitude information for the location whereat the semiconductor aligner is currently installed, and stores the information in the RAM 102 (step 501). The main CPU 110 reads, from the reticle transport device 112, the composite ID (a combination of the inherent apparatus serial number and information for the location whereat the apparatus is installed) that is written on a special optical part, such as a reticle, and stores the composite ID in the RAM 102 (step 502).

The console CPU 101 then transmits, via the communication interface 109 and the communication device 116, the GPS reception data (latitude and longitude information) obtained from the GPS receiver 108 and the composite ID (the serial number inherent to the apparatus and the location information) that is read from the reticle transport device 112 (step 503).

In the server 150, the CPU 151 receives the GPS reception data and the composite ID data from the semiconductor aligner via the communication device 156 and the communication interface 159, and stores these data in the memory 152. The CPU 151 compares the latitude and longitude information, which is included in the GPS reception data for the location whereat the apparatus is installed, with the latitude and longitude information for the location of a user apparatus for which remote access should be permitted. Then, the CPU 151 determines whether the difference between the information falls within the allowed latitude and longitude offset range (step 504). The latitude and longitude information for the location of the user apparatus for which remote access should be permitted, and the allowed latitude and longitude offset range are stored in the memory 152.

Then, the CPU 151 determines whether the composite ID is on the list of IDs, for which remote access is permitted (step 506), that is stored in the memory 152.

Further, the CPU 151 compares the location information, for the apparatus that is included in the composite ID received from the semiconductor aligner, with the latitude and longitude information included in the GPS reception information (step 507).

When, as the result at step 504 it is determined that the latitude and longitude information for the location whereat the semiconductor aligner is currently installed is outside the offset range, it is ascertained that the latitude and longitude information is unlawful location data, or is invalid GPS reception data that has been altered or forged (step 508). Program control is then shifted to step 511, and the communication device 156 is disconnected from the semiconductor manufacturing apparatus. The remote access is thereafter terminated. Therefore, when the latitude and longitude information received by the GPS receiver 108 differs from the information stored in the memory 152, a remote access can be immediately halted.

Similarly, when, as a comparison result obtained at step 506, the composite ID is not on the list of IDs for which the remote access is permitted, it is ascertained that the composite ID is an illegal ID (step 509). Program control is then shifted to step 511, and the remote access is terminated. Therefore, when the ID written on a special optical part, such as a reticle, differs from the ID stored in the memory 152, the remote access can be immediately terminated.

In addition, when, as the comparison result at step 507, the location information in the composite ID differs from the latitude and longitude information in the GPS reception data (step 510), program control is shifted to step 511 and remote access is terminated. Therefore, when the location information for the apparatus written on a special optical part, such as a reticle, does not match the GPS data received by the GPS receiver 108, the remote access can be immediately terminated.

Through the above processing, a multiple level illegal access prevention system can be provided by using the composite ID that includes the location information for the apparatus, so that an illegal access can more accurately be prevented.

However, since the communication interface with the network is located between the GPS receiver 108 and the apparatus, the illegal copying prevention system of the embodiment may be damaged by the alteration or the decryption of the network packet contents. Therefore, if possible, it is preferable that the GPS receiver 108 and an interface that can not be separated from the apparatus be internally provided for the apparatus.

The program code that implements the functions of the embodiment, and means for supplying the program code to a computer, a memory medium, for example, on which the program code is stored, constitutes the present invention. The memory medium used for the recording of such program code can be, for example, a floppy disk, a hard disk, an optical disk, a magneto-optical disk, a CD-ROM, a magnetic tape, a nonvolatile memory card or a ROM.

In addition, the present invention includes not only a case wherein the functions in the previous embodiments can be performed when program code is executed by the computer, but also a case wherein the program code interacts with an OS (Operating System) running on the computer, or with another software application to accomplish the functions described in the above embodiments.

Furthermore, the present invention includes a case wherein program code, read from a storage medium, is written in a memory that is mounted on a function expansion board inserted into a computer, or into a function expansion unit connected to a computer, and in consonance with a program code instruction, a CPU mounted on the function expansion board, or in the function expansion unit, performs part or all of the actual processing required to implement the functions in the above described embodiments.

The shapes and structures of the individual sections in the embodiments are merely specific examples for carrying out the embodiments, and the technical scope of the invention should not be limited to the ones described. That is, the present invention can be variously modified without departing from the scope or the main feature of the invention.

What is claimed is:

1. A software execution method comprising:
a detection step of detecting a location; and
a termination step of terminating the execution of software in accordance with said location.

2. A software execution method according to claim 1, wherein, at said termination step, the execution of said software is terminated at a location other than a predetermined location.

3. A software execution method according to claim 1, wherein, at said detection step, a location is detected from a GPS signal received by a GPS receiver.

4. A software execution method according to claim 1, wherein, at said termination step, the execution of software for controlling semiconductor manufacturing procedures is terminated.

5. A software execution method according to claim 1, wherein, at said termination step, the execution of remote access software is terminated.

6. A software execution method according to claim 1, wherein, at said termination step, information written on a part is read and the execution of software is terminated in accordance with said information and said detected location.

7. A software execution apparatus comprising:
detection means for detecting a location; and
termination means for terminating the execution of software in accordance with said location.

8. A software execution apparatus according to claim 7, wherein said termination means terminates the execution of said software at a location other than a predetermined location.

9. A software execution apparatus according to claim 7, wherein said detection means detects a location from a GPS signal received by a GPS receiver.

10. A software execution apparatus according to claim 7, wherein said termination means terminates the execution of software for controlling semiconductor manufacturing procedures.

11. A software execution apparatus according to claim 7, wherein said termination means terminates the execution of remote access software.

12. A software execution apparatus according to claim 7, wherein said termination means reads information written on a part, and terminates the execution of software in accordance with said information and said detected location.

13. A storage medium on which is stored a program comprising:
a detection step of detecting a location; and
a termination step of terminating the execution of software in accordance with said location.

14. A storage medium according to claim 13, wherein, at said termination step, the execution of said software is terminated at a location other than a predetermined location.

15. A storage medium according to claim 13, wherein, at said detection step, a location is detected from a GPS signal received by a GPS receiver.

16. A storage medium according to claim 13, wherein, at said termination step, the execution of software for controlling semiconductor manufacturing procedures is terminated.

17. A storage medium according to claim 13, wherein, at said termination step, the execution of remote access software is terminated.

18. A storage medium according to claim 13, wherein, at said termination step, information written on a part is read and the execution of software is terminated in accordance with said information and said detected location.

19. A software execution method comprising:
a reception step of receiving a GPS signal from a GPS receiver; and
a termination step of terminating the execution of software in accordance with said GPS signal.

20. A software execution method according to claim 19, wherein at said termination step the execution of software is terminated in accordance with time information included in said GPS signal.

21. A software execution apparatus comprising:
reception means for receiving a GPS signal from a GPS receiver; and
termination means for terminating the execution of software in accordance with said GPS signal.

22. A software execution apparatus according to claim 21, wherein said termination means terminates the execution of software in accordance with time information included in said GPS signal.

23. A storage medium on which is stored a program comprising:
a reception step of receiving a GPS signal from a GPS receiver; and
a termination step of terminating the execution of software in accordance with said GPS signal.

24. A storage medium according to claim 23, wherein at said termination step the execution of software is terminated in accordance with time information included in said GPS signal.

25. A monitoring apparatus comprising:
first reception means, for receiving a notification signal from a monitor target apparatus;
second reception means, for receiving a GPS signal; and
monitoring means, for employing said notification signal and said GPS signal to monitor the legality of software used by said monitor target apparatus.

26. A remote access control apparatus comprising:
determination means, for determining the location of a remote access station; and
control means, for terminating a remote access in accordance with said location of said remote access station.

27. A remote access apparatus comprising:
reading means, for reading apparatus information recorded on an optical part; and
transmission means, for transmitting to a remote access destination, in order to notify an apparatus for which remote access is permitted, said apparatus information obtained by said reading means.

28. A remote access apparatus according to claim 27, wherein said transmission means transmits said apparatus information and a GPS signal.

29. A software management apparatus comprising:
information acquisition means, for externally obtaining time information and/or location information; and
halting means, for halting the execution of software in accordance with a comparison of said time information and/or said location information with information written in said software.

30. A software management apparatus according to claim 29, wherein said information acquisition means obtains said time information and/or said location information from a GPS receiver.

31. A network system wherein remote access is performed between a first apparatus and a second apparatus; wherein said first apparatus includes location information acquisition means for obtaining location information for said first apparatus, and transmission means for transmitting said location information obtained by said location information acquisition means; and wherein said second apparatus includes reception means for receiving said location information from said transmission means, and disconnection means for halting a remote access in accordance with said location information received by said reception means.

32. A remote access execution apparatus comprising:
location information acquisition means, for Obtaining location information for said remote access execution apparatus; and
transmission means, for transmitting to a predetermined apparatus, while remotely accessing said predetermined apparatus, said location information that is obtained by said location information acquisition means in order to notify an apparatus for which remote access is permitted.

33. A network system wherein remote access between a first apparatus and a second apparatus is effected; wherein said first apparatus includes location information acquisition means for obtaining first location information for said first apparatus, ID information acquisition means for obtaining ID information, including second location information for said first apparatus, and transmission means for transmitting said first location information and said ID information; and wherein said second apparatus includes reception means for receiving said first location information and said ID information from said transmission means, and disconnection means for halting a remote access in accordance with said first location information and said second location information included in said ID information.
